(19) United States
(12) Patent Application Publication
(10) Pub. No.: US 2023/0319892 A1
(43) Pub. Date: Oct. 5, 2023

(54) TRANSFERRING DATA SEGMENTS AFTER PERFORMING A RANDOM ACCESS CHANNEL (RACH) PROCEDURE

(71) Applicant: QUALCOMM Incorporated, San Diego, CA (US)

(72) Inventors: Ruiming ZHENG, Beijing (CN); Linhai HE, San Diego, CA (US)

(21) Appl. No.: 18/023,237

(22) PCT Filed: Oct. 13, 2020
(86) PCT No.: PCT/CN2020/120603

§ 371 Date: Feb. 24, 2023

(51) Int. Cl. H04W 74/08; H04W 74/00

(52) U.S. Cl. CPC H04W 74/0833; H04W 74/006

(57) ABSTRACT

This disclosure relates to transferring data segments, and includes a method and apparatus for performing a random access channel (RACH) procedure with a network entity for transferring a first portion of a plurality of data segments from a user equipment (UE) to the network entity during a radio resource control (RRC) inactive state, wherein the RACH procedure comprises receiving a physical downlink control channel (PDCCH) configuration from the network entity, the PDCCH configuration including an identified search space; and monitoring a PDCCH for PDCCH candidates addressed by a UE-specific network identifier in the identified search space for dynamic scheduling information that schedules a second portion of the plurality of data segments.

### TECHNICAL FIELD

The present disclosure relates generally to communication systems, and more particularly, to enhancements in transferring data segments after performing a random access channel (RACH) procedure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard.

There exists a need for further improvements in 5G NR technology, such as with regard to improving the efficiency in transmitting data. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method of wireless communication at a user equipment (UE), comprising performing a random access channel (RACH) procedure with a network entity for transferring a first portion of a plurality of data segments from the UE to the network entity during a radio resource control (RRC) inactive state, wherein the RACH procedure comprises receiving a physical downlink control channel (PDCCH) configuration from the network entity, the PDCCH configuration including an identified search space; and monitoring a PDCCH for PDCCH candidates addressed by a UE-specific network identifier in the identified search space for dynamic scheduling information that schedules a second portion of the plurality of data segments.

Another example implementation includes a method of wireless communication at a base station, including performing a RACH procedure with a UE in an RRC inactive state for receiving a first portion of a plurality of data segments, wherein the RACH procedure comprises transmitting a PDCCH configuration to the UE, the PDCCH configuration including an identified search space; and transmitting, on the PDCCH, dynamic scheduling information in one or more PDCCH candidates addressed by a UE-specific network identifier in the identified search space for scheduling a second portion of the plurality of data segments.

In a further example, an apparatus for wireless communication is provided that includes a transceiver, a memory configured to store instructions, and one or more processors communicatively coupled with the transceiver and the memory. The one or more processors are configured to execute the instructions to perform the operations of the methods described herein.

In another aspect, an apparatus for wireless communication is provided that includes means for performing the operations of methods described herein.

In yet another aspect, a non-transitory computer-readable medium is provided including code executable by one or more processors to perform the operations of the methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a wireless communications system in accordance with one or more aspects of the present disclosure.

FIGS. 2A, 2B, 2C, and 2D are diagrams of examples of a first 5G/NR frame, DL channels within a 5G/NR subframe, a second 5G/NR frame, and UL channels within a 5G/NR subframe, respectively, for use in communications between two of the communicating nodes in the system of FIG. 1 in accordance with one or more aspects of the present disclosure.

FIG. 3 is a diagram of an example frame structure and resources for sidelink communications between two of the communicating nodes in the system of FIG. 1 in accordance with one or more aspects of the present disclosure.

FIG. 4 is a schematic diagram of an example of hardware components of two of the communicating nodes in the system of FIG. 1 in accordance with one or more aspects of the present disclosure.

FIG. 5 is a schematic diagram of an example of an uplink data segment transmission during two-step random access channel (RACH) procedure with subsequent uplink data segment transmission in configured grant resources operable in the system of FIG. 1 in accordance with one or more aspects of the present disclosure.

FIG. 6 is a schematic diagram of an example of an uplink data segment transmission during four-step RACH procedure with subsequent uplink data segment transmission in configured grant resources operable in the system of FIG. 1 in accordance with one or more aspects of the present disclosure.

FIG. 7 is a schematic diagram of an example of an uplink data segment transmission during two-step RACH procedure with subsequent uplink data segment transmission in dynamic grant resources operable in the system of FIG. 1 in accordance with one or more aspects of the present disclosure.

FIG. 8 is a schematic diagram of an example of an uplink data segment transmission during four-step RACH procedure with subsequent uplink data segment transmission in dynamic grant resources operable in the system of FIG. 1 in accordance with one or more aspects of the present disclosure.

FIG. 9 is a schematic diagram of an example of traffic pattern between a user equipment (UE) and a base station using dynamic grant and configured grant operable in the system of FIG. 1 in accordance with one or more aspects of the present disclosure.

FIG. 10 is a flowchart of another example method of wireless communication of a UE operable in the system of FIG. 1 in accordance with one or more aspects of the present disclosure.

FIG. 11 is a flowchart of another example method of wireless communication of a network entity operable in the system of FIG. 1 in accordance with one or more aspects of the present disclosure.

FIG. 12 is a block diagram of an example UE, in accordance with various aspects of the present disclosure.

FIG. 13 is a block diagram of an example base station, in accordance with various aspects of the present disclosure.

An Appendix is included that is part of the present application and provides additional details related to the various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present aspects generally relate to transferring additional data segments in an inactive state using dynamic scheduling, after performing a random access channel (RACH) procedure in which an initial data segment is transferred. For example, a user equipment (UE) may enter an inactive state, such as a radio resource control (RRC) inactive state, to conserve battery power and network resources in times of infrequent data traffic. Entering an active state from the inactive state may involve a RACH procedure or another form of establishment procedure. In some instances, the UE may generate only a small amount of data across a burst in a data session. Examples of such instances include enhanced mobile broadband (eMBB) communications, Internet of Things (IoT) communications, instant messaging applications, social media applications, wearable device applications, and/or the like. It may be wasteful of the UE’s resources and network resources to reestablish an RRC connection solely to transmit a small data burst.

In an aspect, radio access technologies may provide a service for transmitting a small data transmission in an inactive state, such as via an uplink RACH message or a configured uplink resource (e.g., a dedicated preconfigured uplink resource, a preconfigured uplink resource, a dedicated uplink resource, and/or the like). However, not all small data transmissions may fit within an uplink RACH message or a configured uplink resource. Furthermore, in some cases, an uplink resource may not be configured for the UE. Therefore, indiscriminately providing a small data transmission via an uplink RACH message or a configured uplink resource (e.g., without regard for the size of the data transmission or the configured uplink resource) may lead to failed uplink transmissions, retransmissions, and/or the like.

Specifically, the present disclosure relates to enhancements to the transferring of data segments in an inactive state after performing a RACH procedure in which a first data segment is transferred from the UE to a base station in the inactive state. For example, after transferring the first data segment to the base station during the RACH procedure, the UE may have a second data segment, e.g., such as a small amount of data across a burst in a data session, remaining to transmit to the base station. Consequently, it is desired for the UE to transmit the second data segment to the base station in an RRC inactive state without the UE having to transition to a RRC connected state.

As such, the present disclosure enables uplink small data transmissions for RACH-based schemes from a RRC inactive state using dynamic scheduling. Specifically, the present disclosure provides apparatus and methods at a UE for performing a RACH procedure with a network entity for transferring a first portion of a plurality of data segments from the UE to the network entity during a RRC inactive state, wherein the RACH procedure comprises receiving a physical downlink control channel (PDCCH) configuration from the network entity, the PDCCH configuration including an identified search space; and monitoring a PDCCH for PDCCH candidates addressed by a UE-specific network identifier in the identified search space for dynamic scheduling information that schedules a second portion of the plurality of data segments.

In another aspect, the present disclosure provides apparatus and methods at a base station or network entity for performing a RACH procedure with a UE in an RRC inactive state for receiving a first portion of a plurality of data segments, wherein the RACH procedure comprises transmitting a PDCCH configuration to the UE, the PDCCH configuration including an identified search space; and transmitting, on the PDCCH, dynamic scheduling information in one or more PDCCH candidates addressed by a UE-specific network identifier in the identified search space for scheduling a second portion of the plurality of data segments.

Consequently, the aspects described herein enable the efficient transfer of a plurality of data segments, such as associated with a small data transmission or data burst utilized by eMBB communications, IoT communications, instant messaging applications, social media applications, wearable device applications, and/or the like, in association with a RACH procedure while maintaining the UE in an inactive state based on dynamic scheduling.

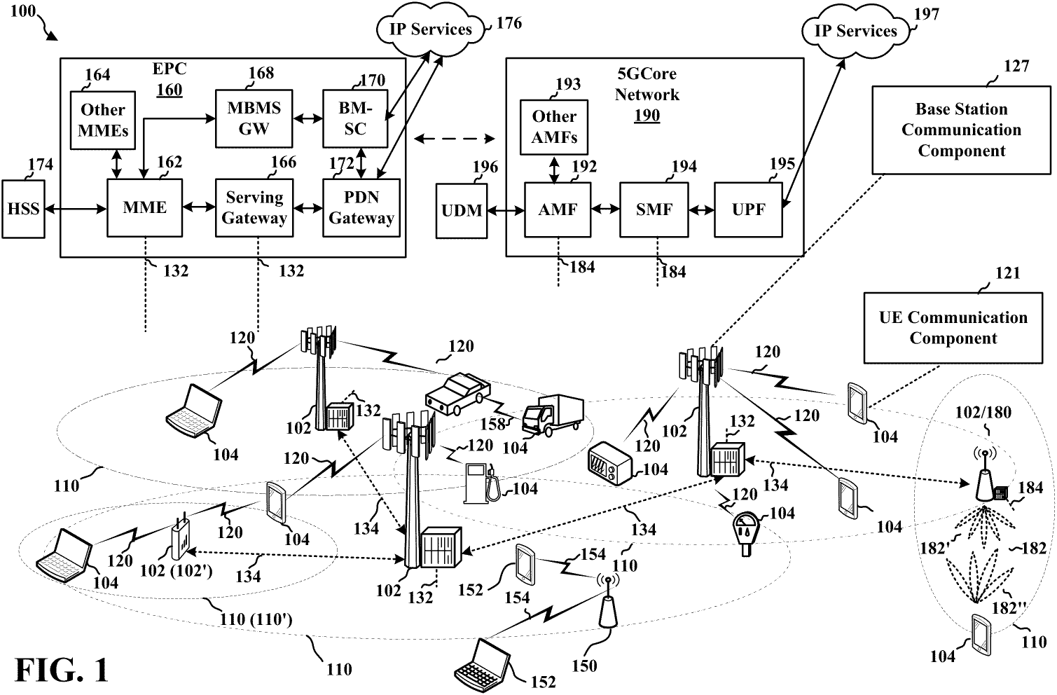

These and other features of the present disclosure are discussed in detail below with regard to FIGS. 1-13.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

FIG. 1 is a diagram illustrating an example of a wireless communications system 100. The wireless communications system (also referred to as a wireless wide area network (WWAN)) includes base stations 102, UEs 104, an Evolved Packet Core (EPC) 160, and another core network 190 (e.g., a 5G Core (5GC)).

In certain aspects, a respective UE 104 may include a UE communication component 121 for performing a RACH procedure with a respective base station 102 to transfer a plurality of data segments to a base station 102 during an inactive state and based on dynamic scheduling. The UE 104 may have an access link 120 directly with the base station 102. The UE communication component 121 of the UE 104 may be selectively configured to transfer data segments during the RACH procedure, and after performing the RACH procedure based on dynamic scheduling, as described herein, all while being an inactive state.

Similarly, the base station 102 may include a base station communication component 127 configured to transfer data segments, including receiving data segments, during and after performing the RACH procedure with the UE 104, as described herein.

Further details of these operations performed by the UE 104 and the base station 102 are discussed in more detail below.

The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5GNR (collectively referred to as Next Generation RAN (NG-RAN)) may interface with 5G core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120, including access links 120a and 120b, between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102 / UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, one example of which includes sidelink 158a. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152 / AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. The electromagnetic spectrum is often subdivided, based on frequency/wavelength, into various classes, bands, channels, etc. In 5G NR two initial operating bands have been identified as frequency range designations FR1 (410 MHz - 7.125 GHz) and FR2 (24.25 GHz - 52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180 / UE 104 may perform beam training to determine the best receive and transmit directions for each of the base station 180 / UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

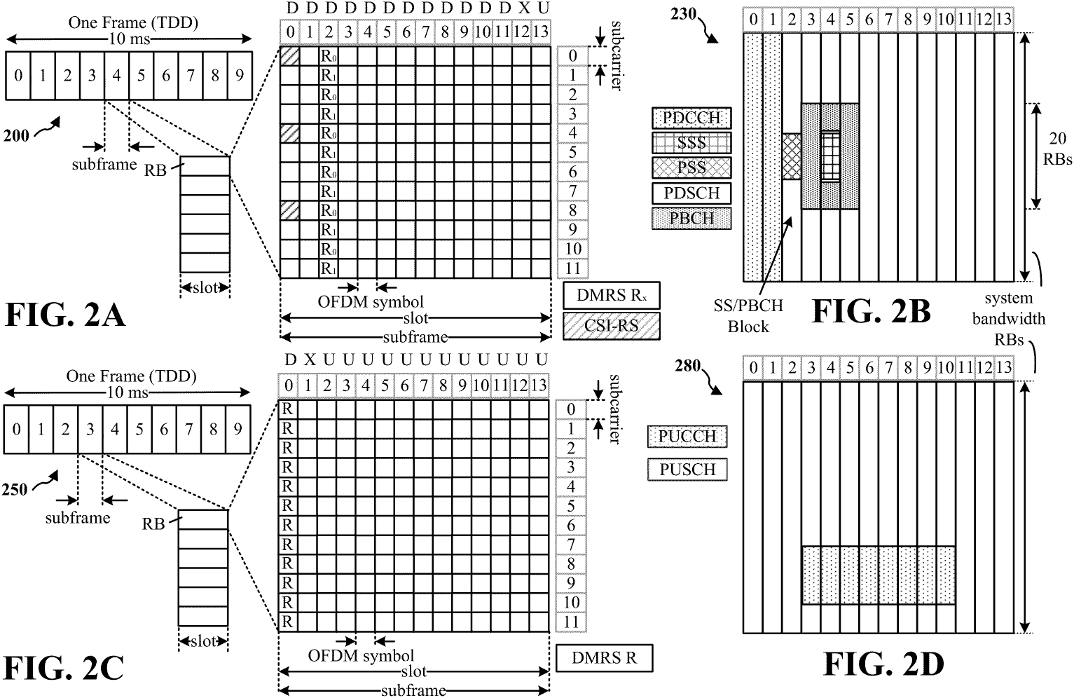

FIGS. 2A-2D include diagrams of example frame structures and resources that may be utilized in communications between the base stations 102, the UEs 104 described in this disclosure. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies µ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology µ, there are 14 symbols/slot and 2^{µ} slots/subframe. The subcarrier spacing and symbol length/duration are a function of the numerology. The subcarrier spacing may be equal to 2^{µ} _{*} 15 kHz, where µ is the numerology 0 to 5. As such, the numerology µ=0 has a subcarrier spacing of 15 kHz and the numerology µ=5 has a subcarrier spacing of 480 kHz. The symbol length/duration is inversely related to the subcarrier spacing. FIGS. 2A-2D provide an example of slot configuration 0 with 14 symbols per slot and numerology µ=0 with 1 slot per subframe. The subcarrier spacing is 15 kHz and symbol duration is approximately 66.7 µs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

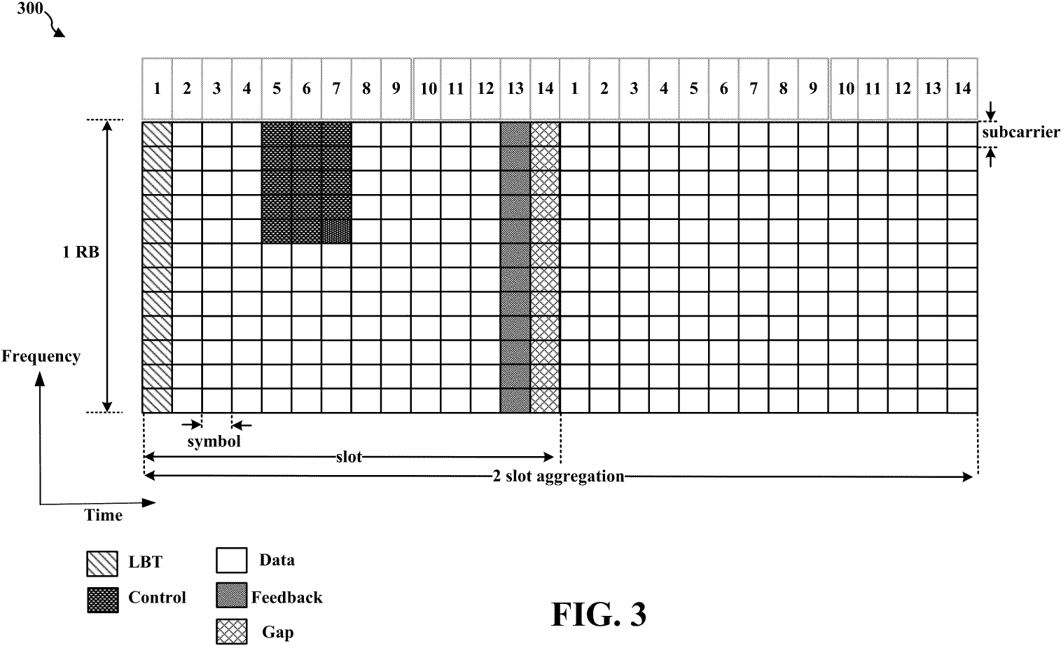

FIG. 3 is a diagram 300 of an example of a slot structure that may be used within a 5G/NR frame structure, e.g., for sidelink communication. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. Some of the REs may comprise control information, e.g., along with demodulation RS (DM-RS). The control information may comprise Sidelink Control Information (SCI). In some implementations, at least one symbol at the beginning of a slot may be used by a transmitting device to perform a Listen Before Talk (LBT) operation prior to transmitting. In some implementations, at least one symbol may be used for feedback, as described herein. In some implementations, another symbol, e.g., at the end of the slot, may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 3. In some implementations, multiple slots may be aggregated together, and the example aggregation of two slots in FIG. 3 should not be considered limiting, as the aggregated number of slots may also be larger than two. When slots are aggregated, the symbols used for feedback and/or a gap symbol may be different that for a single slot.

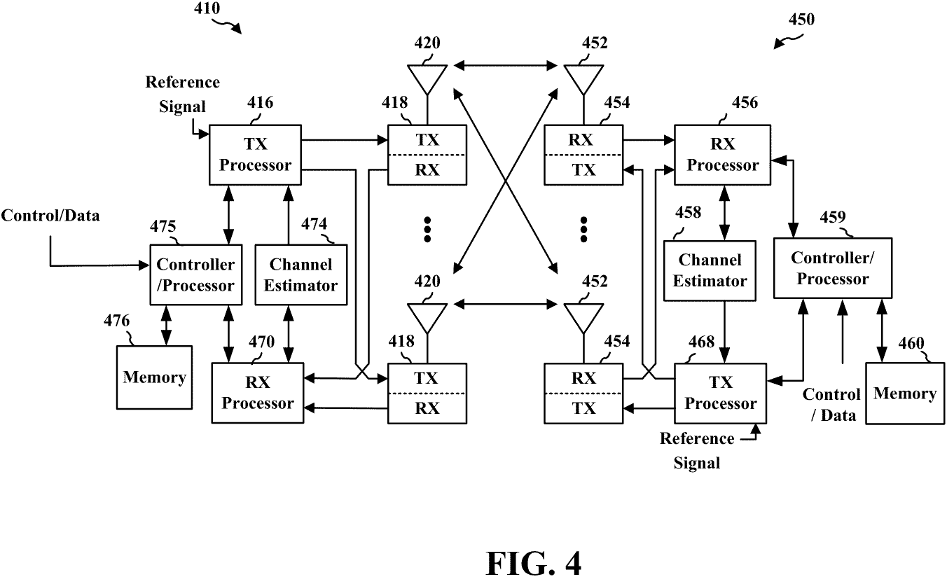

FIG. 4 is a diagram of hardware components of an example transmitting and/or receiving (TX/RX) nodes 410 and 450, which may be any combinations of base station 102 - UE 104 communications, and/or UE 104 - UE 104 communications in system 100. For example, such communications may including, but are not limited to, communications such as a base station transmitting to a UE, a UE transmitting to a second UE, a second UE transmitting to a UE, or a UE transmitting to a base station in a wireless communications system. In one specific example, the TX/RX node 410 may be an example implementation of base station 102 and where TX/RX node 450 may be an example implementation of UE 104. In the DL, IP packets from the EPC 160 may be provided to a controller/processor 475. The controller/processor 475 implements layer 4 and layer 2 functionality. Layer 4 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression / decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the tx/rx node 450. Each spatial stream may then be provided to a different antenna 420 via a separate transmitter 418TX. Each transmitter 418TX may modulate an RF carrier with a respective spatial stream for transmission.

At the TX/RX node 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the TX/RX node 450. If multiple spatial streams are destined for the TX/RX node 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the TX/RX node 410. These soft decisions may be based on channel estimates computed by the channel estimator 458. The soft decisions are then decoded and deinterleaved to recover the data and control signals that were originally transmitted by the TX/RX node 410 on the physical channel. The data and control signals are then provided to the controller/processor 459, which implements layer 4 and layer 2 functionality.

The controller/processor 459 can be associated with a memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the TX/RX node 410, the controller/processor 459 provides RRC layer functionality associated with system information (e.g., MIB, SIBs) acquisition, RRC connections, and measurement reporting; PDCP layer functionality associated with header compression / decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the TX/RX node 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the TX/RX node 410 in a manner similar to that described in connection with the receiver function at the TX/RX node 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets from the tx/rx node 450. IP packets from the controller/processor 475 may be provided to the EPC 160. The controller/processor 475 is also responsible for error detection using an ACK and/or NACK protocol to support HARQ operations.

In an implementation at a UE, at least one of the TX processor 468, the RX processor 456, and the controller/processor 459 may be configured to perform aspects in connection with UE communication component 121 of FIG. 1.

In an implementation at a base station or network entity, at least one of the TX processor 416, the RX processor 470, and the controller/processor 475 may be configured to perform aspects in connection with base station communication component 127 of FIG. 1.

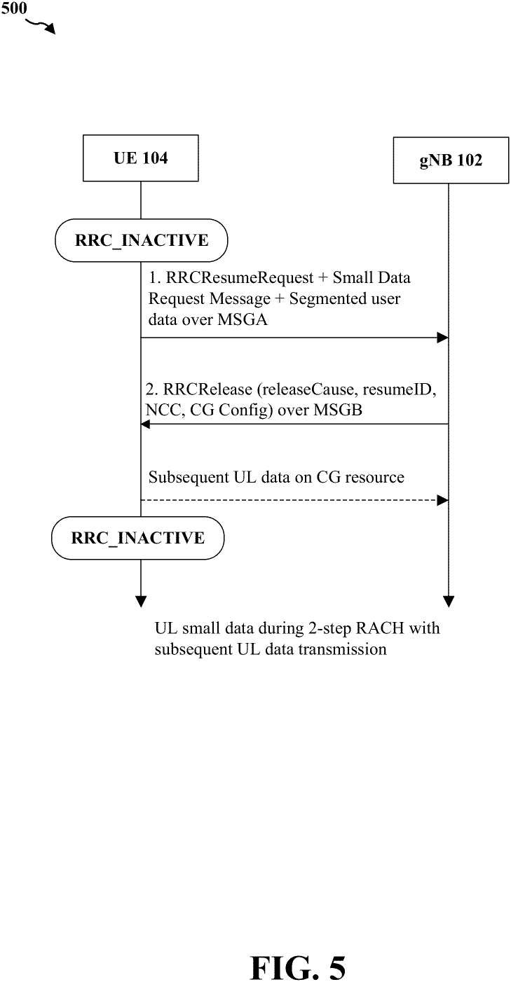

Referring to FIG. 5, a schematic diagram 500 illustrating an example of an uplink data segment transmission during two-step RACH procedure with subsequent uplink data segment transmission using configured grant resources operable in the system of FIG. 1 is described. For example, UE 104 and base station 102 (e.g., gNB) may communicate with one another to perform the two-step RACH procedure with subsequent uplink data segment transmission in configured grant resources.

In an aspect, UE 104 may be configured in a RRC inactive state. At step 1, UE 104 may transmit a RRC resume request message with a small data request message and segmented user data over MSGA to base station 102. At step 2, base station 102 may transmit a RRC release message over the MSGB to UE 104. The RRC release message may include one or more information elements, such as a releaseCause, which indicates a cause for the release, a resumeID, which may be an access stratum context identifier to be used for contention resolution, an nextHopChainingCount (NCC) corresponding to a security parameter used for ciphering the user data to be transmitted, and CG Config, which indicates a configured grant configuration. After receiving the RRC release message, UE 104 may transmit subsequent uplink data on the configured grant resource. UE 104 may remain in the RRC inactive state during the procedure.

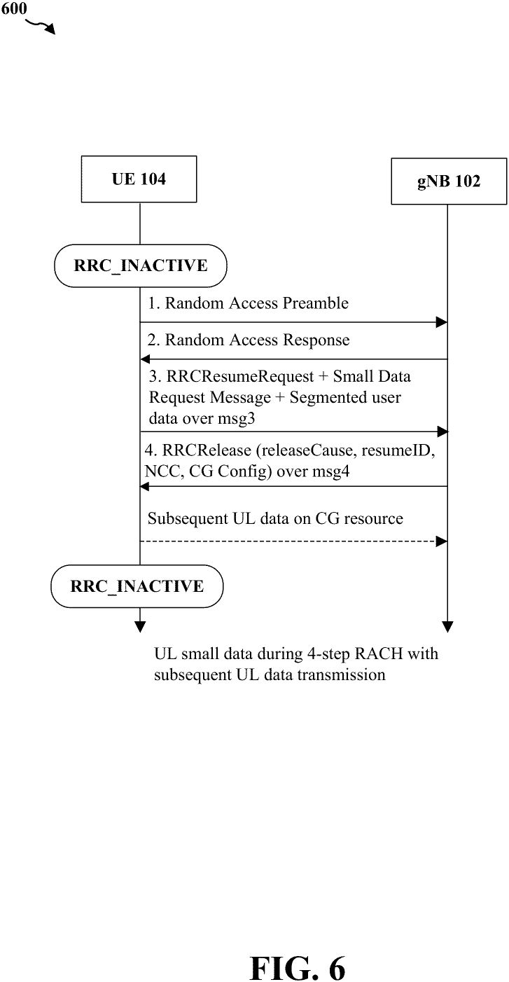

Referring to FIG. 6, a schematic diagram 600 illustrating an example of an uplink data segment transmission during four-step RACH procedure with subsequent uplink data segment transmission using configured grant resources operable in the system of FIG. 1 is described. For example, UE 104 and base station 102 (e.g., gNB) may communicate with one another to perform the four-step RACH procedure with subsequent uplink data segment transmission in configured grant resources.

In an aspect, UE 104 may be configured in a RRC inactive state. At step 1, UE 104 may transmit a random access preamble to base station 102. At step 2, base station 102 may transmit a random access response to UE 104. At step 3, UE 104 may transmit a RRC resume request message with a small data request message and segmented user data over MSG3 to base station 102. At step 4, base station 102 may transmit a RRC release message over the MSG4 to UE 104. The RRC release message may include information such as releaseCause, resumeID, NCC, and CG Config. After receiving the RRC release message, UE 104 may transmit subsequent uplink data on the configured grant resource. UE 104 may remain in the RRC inactive state during the procedure.

In contrast to using a configured grant, according to the present aspects, subsequent user small data transmission can also utilize network dynamic scheduling in the RACH-based schemes for small data transfer. The present aspects address the issue as to how to configure the dynamic scheduling resource, such as a SearchSpace, in the RACH procedure for UE subsequent small data transfer. Additionally, the present aspects provide a procedure for the subsequent small data transmission using a dynamic grant from the dynamic scheduling.

Regarding the SearchSpace configuration for PDCCH monitoring, for example, the present aspects provide for configuring an identified search space, including a UE-specific search space or a common search space. For example, the common search space may include, but is not limited to, a random access-specific search space, e.g., ra-SearchSpace. Moreover, the present aspects provide for the UE to monitor for PDCCH candidates addressed by a UE-specific network identifier in the identified search space. For example, the UE-specific network identifier may include, but is not limited to, a C-RNTI.

Further, the present aspects provide the identified SearchSpace for PDCCH monitoring in an inactive state, e.g., the RRC_INACTIVE state.

In a first option, UE 104 monitors the PDCCH addressed by the C-RNTI for subsequent small data transfer in the ra-SearchSpace. For example, UE 104 has not been provided a Type3-PDCCH CSS set or a USS set and UE 104 has received a C-RNTI and has been provided a Type1-PDCCH CSS set, then UE 104 monitors PDCCH candidates for DCI format 0_0 and DCI format 1_0 with CRC scrambled by the C-RNTI in the Type1-PDCCH CSS set.

In a second option, a UE-specific SearchSpace may be used by UE 104 for PDCCH monitoring for subsequent small data transfer. For example, a PDCCH-Config comprising UE-specific SearchSpace is configured in the RRC Release message (e.g., RRCRelease with suspendConfig for keeping UE 104 in RRC_INACTIVE). UE 104 monitors PDCCH addressed by C-RNTI in the UE-specific SearchSpace.

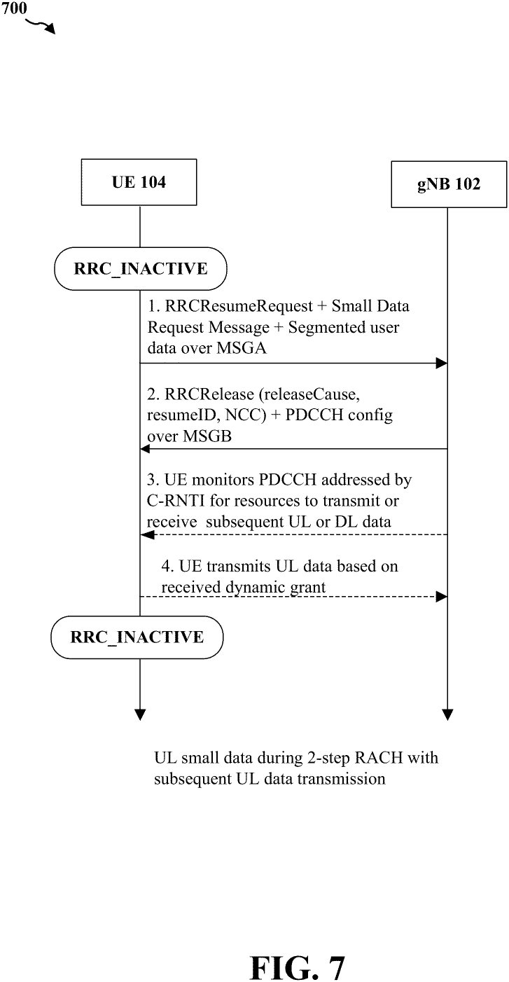

Referring to FIG. 7, a schematic diagram 700 illustrating an example of an uplink data segment transmission during two-step RACH procedure with subsequent uplink data segment transmission using dynamic grant resources operable in the system of FIG. 1 is described. For example, UE 104 and base station 102 (e.g., gNB) may communicate with one another to perform the two-step RACH procedure with subsequent uplink data segment transmission in dynamic grant resources.

In an aspect, UE 104 may be configured in a RRC inactive state. At step 1, UE 104 may transmit a RRC resume request message with a small data request message and segmented user data over MSGA to base station 102. The small data request message may include a buffer status report that indicates an amount of data in a transmit buffer of the UE. For example, the buffer status report may include a buffer status report medium access control (MAC) control element (BSR MAC CE). At step 2, base station 102 may transmit a RRC release message with a PDCCH configuration over the MSGB to UE 104. The RRC release message may include information such as releaseCause, resumeID, and NCC. At step 3, after receiving the RRC release message and PDCCH configuration, UE 104 may monitor the PDCCH addressed by the C-RNTI for resource grants to enable transmitting or receiving subsequent uplink (UL) and downlink (DL) data. For example, at step 4, UE 104 transmits subsequent UL data based on receiving dynamic scheduling information in step 3 that includes a dynamic UL grant. UE 104 may remain in the RRC inactive state during the procedure.

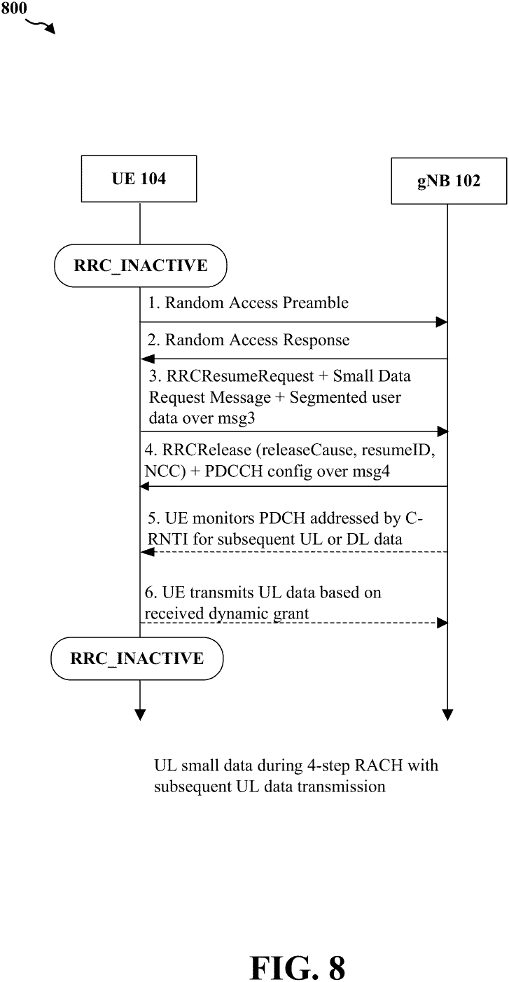

Referring to FIG. 8, a schematic diagram 800 illustrating an example of an uplink data segment transmission during four-step RACH procedure with subsequent uplink data segment transmission in dynamic grant resources operable in the system of FIG. 1 is described. For example, UE 104 and base station 102 (e.g., gNB) may communicate with one another to perform the four-step RACH procedure with subsequent uplink data segment transmission in dynamic grant resources.

In an aspect, UE 104 may be configured in a RRC inactive state. At step 1, UE 104 may transmit a random access preamble to base station 102. At step 2, base station 102 may transmit a random access response to UE 104. At step 3, UE 104 may transmit a RRC resume request message with a small data request message and segmented user data over MSG3 to base station 102. At step 4, base station 102 may transmit a RRC release message and a PDCCH configuration over the MSG4 to UE 104. The RRC release message may include information such as releaseCause, resumeID, and NCC. At step 5, after receiving the RRC release message and the PDCCH configuration, UE 104 monitors the PDCCH addressed by the C-RNTI for subsequent uplink and downlink data. Additionally, at step 6, UE 104 transmits subsequent UL data based on receiving dynamic scheduling information in step 5 that includes a dynamic UL grant. UE 104 may remain in the RRC inactive state during the procedure.

In other words, referring to FIGS. 7 and 8, the present aspects provide a scheme for subsequent small data transfer by dynamic scheduling. The procedure includes the UE sending the (segmented) user small data in MSGA or Msg3 or sending the Small Data Request message in PUSCH of MSGA or Msg3. In these aspects, the Small Data Request Message may include, at least, a Buffer Status Report, such as but not limited to a BSR MAC CE. Further the procedure includes the UE monitoring the PDCCH addressed by C-RNTI for subsequent scheduling packets (both in uplink (UL) or downlink (DL)). Hence, the network entity, e.g., gNB, may transmit a DL response message and schedule the UE for further UL transmission using the C-RNTI based scheduling (e.g., dynamic scheduling).

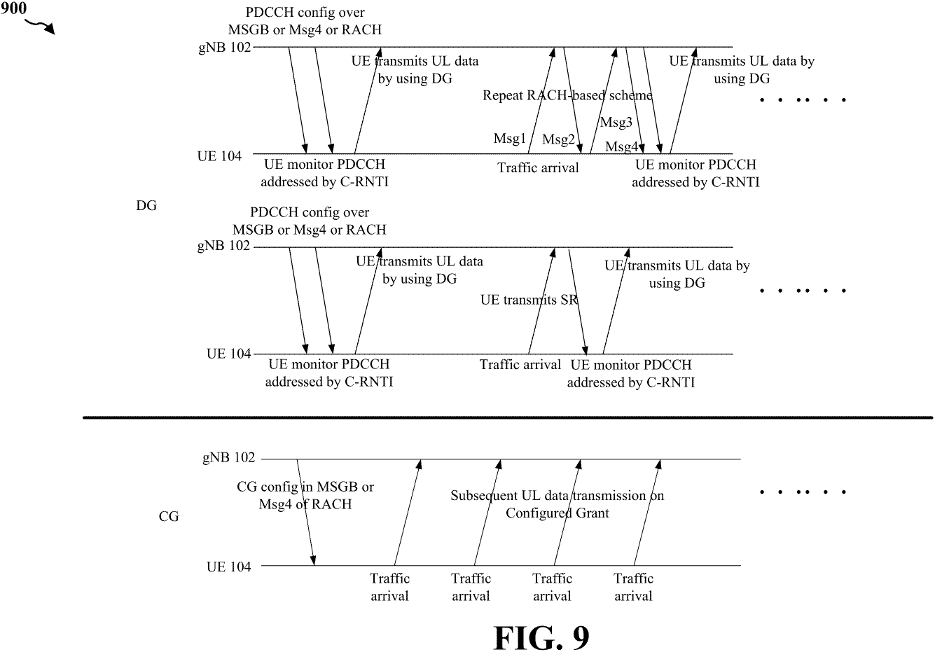

Referring to FIG. 9, a schematic diagram 900 illustrating an example of traffic pattern between a UE, such as UE 104, and a base station, such as base station 102, using dynamic grant and configured grant operable in the system of FIG. 1 is disclosed.

In an aspect, for a dynamic grant configuration, the base station 102 may transmit the PDCCH configuration over the MSGB, MSG4, or RACH. UE 104 may monitor the PDCCH addressed by the C-RNTI and transmit uplink data using the dynamic grant. In some instances, transmitting subsequent small data by using dynamic grant after a RACH procedure may be less efficient as compared to using a configured grant. The dynamic grant resource may only be suitable for handling one-shot traffic for subsequent small data transfers. The multi-shot traffic pattern may include UE 104 transmitting a first object and as a result the buffer of the UE 104 becomes empty. In response to receiving an acknowledgement (ACK) from base station 102, the application layer of UE 104 may generate another object to transmit. If UE 104 has a multi-shot traffic pattern with gaps, then either UE 104 may repeat another RACH procedure to handle the small data for the next shot traffic, or UE 104 may transmit a scheduling request to require base station 102 to configure more uplink grant resources in the RRC inactive state. The PUCCH resource used to transmit the scheduling request may also require base station 102 to configure in the RRC inactive state.

In an aspect, subsequent small data transfer by using configured grant may more efficiently support multi-shot traffic patterns as compared to dynamic grant. For example, by using a configured grant, there is no need to repeat the RACH procedure to handle the multi-shot traffic. In another example, there is no need to transmit a scheduling request or buffer status report to require more uplink resources from base station 102.

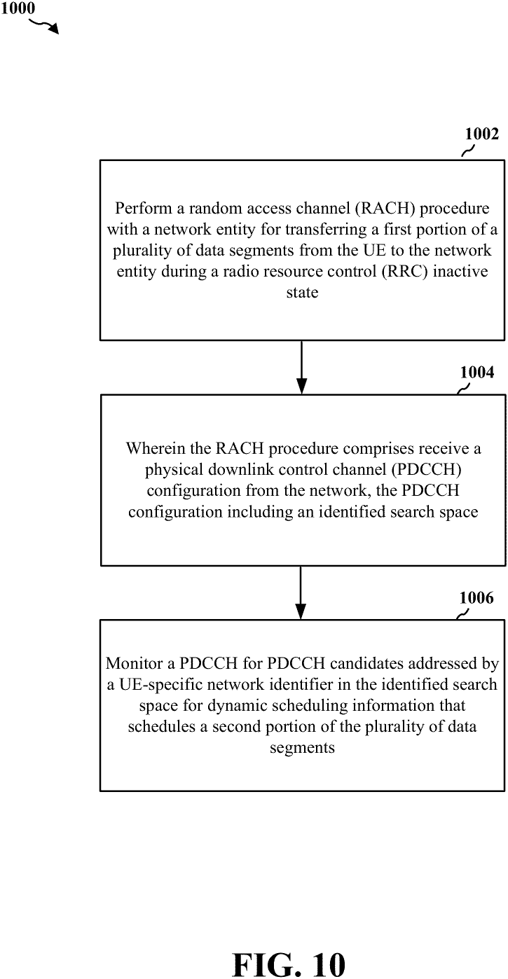

Referring to FIG. 10, an example method 1000 of wireless communication may be performed by the UE 104, which may include one or more components as discussed in FIGS. 1, 4, or 12, and which may transfer data segments after performing a RACH procedure as discussed above with regard to FIGS. 1-4 and 7-8.

At 1002, method 1000 includes performing a RACH procedure with a network entity for transferring a first portion of a plurality of data segments from the UE to the network entity during a RRC inactive state. For example, in an aspect, the UE 104 may operate one or any combination of antennas 1265, RF front end 1288, transceiver 1202, processor 1212, memory 1216, modem 1240, or communication component 121 to perform a RACH procedure with a network entity for transferring a first portion of a plurality of data segments from the UE to the network entity during a RRC inactive state. Thus, the UE 104, antennas 1265, RF front end 1288, transceiver 1202, processor 1212, memory 1216, modem 1240, and communication component 121 may define the means for performing a RACH procedure with a network entity for transferring a first portion of a plurality of data segments from the UE to the network entity during a RRC inactive state. For instance, performing the RACH procedure for transferring a first portion of a plurality of data segments from the UE to the network entity during a RRC inactive state at 1002 includes, for example, steps 1 and 2 of FIG. 7 and/or steps 1 through 4 of FIG. 8 .

At 1004, method 1000 includes wherein the RACH procedure comprises receiving a PDCCH configuration from the network entity, the PDCCH configuration including an identified search space. For example, in an aspect, the UE 104 may operate one or any combination of antennas 1265, RF front end 1288, transceiver 1202, processor 1212, memory 1216, modem 1240, or communication component 121 to receive a PDCCH configuration from the network entity as a part of the RACH procedure, the PDCCH configuration including an identified search space. Thus, the UE 104, antennas 1265, RF front end 1288, transceiver 1202, processor 1212, memory 1216, modem 1240, and UE communication component 121 may define the means for wherein the RACH procedure comprises receiving a PDCCH configuration from the network entity, the PDCCH configuration including an identified search space. For instance, performing the RACH procedure for transferring a first portion of a plurality of data segments from the UE to the network entity during a RRC inactive state at 1004 includes, for example, step 2 of FIG. 7 and/or step 4 of FIG. 8.

At 1006, method 1000 includes monitoring a PDCCH for PDCCH candidates addressed by a UE-specific network identifier in the identified search space for dynamic scheduling information that schedules a second portion of the plurality of data segments. For example, in an aspect, the UE 104 may operate one or any combination of antennas 1265, RF front end 1288, transceiver 1202, processor 1212, memory 1216, modem 1240, or UE communication component 121 to monitor a PDCCH for PDCCH candidates addressed by a UE-specific network identifier in the identified search space for dynamic scheduling information that schedules a second portion of the plurality of data segments. Thus, the UE 104, antennas 1265, RF front end 1288, transceiver 1202, processor 1212, memory 1216, modem 1240, and UE communication component 121 may define the means for monitoring a PDCCH for PDCCH candidates addressed by a UE-specific network identifier in the identified search space for dynamic scheduling information that schedules a second portion of the plurality of data segments. For instance, performing the RACH procedure for transferring a first portion of a plurality of data segments from the UE to the network entity during a RRC inactive state at 1006 includes, for example, step 3 of FIG. 7 and/or step 5 of FIG. 8.

In some implementations of method 1000, the identified search space comprises a UE-specific search space, or a common search space, such as but not limited to a random access-specific search space.

In some implementations of method 1000, the UE communication component 121, such as in conjunction with transceiver 1202, processor 1212, memory 1216, or modem 1240, configured to perform the RACH procedure with the network entity for transferring the first portion of a plurality of data segments further comprises transmitting a small data request message including a buffer status report indicating a buffer value corresponding to the second portion of the plurality of data segments.

In some implementations of method 1000, the UE communication component 121, such as in conjunction with transceiver 1202, processor 1212, memory 1216, or modem 1240, configured to receive the PDCCH configuration further comprises receiving the PDCCH configuration including the identified search space in a RRC release message.

In some implementations of method 1000, the RRC release message includes a suspend configuration indicator for maintaining the UE in a RRC inactive state.

In some implementations of method 1000, the UE-specific network identifier comprises a cell-radio network temporary identifier (C-RNTI).

In some implementations of method 1000, the UE communication component 121, such as in conjunction with transceiver 1202, processor 1212, memory 1216, or modem 1240, configured to monitor the PDCCH for the dynamic scheduling information that schedules the second portion of the plurality of data segments includes monitoring for scheduling data packets that schedule resources in at least one of an uplink channel or a downlink channel.

In some implementations of method 1000, the UE communication component 121, such as in conjunction with transceiver 1202, processor 1212, memory 1216, or modem 1240, is configured to receive a downlink response message from the network entity, the downlink response message including the dynamic scheduling information for an uplink transmission, using the UE-specific network identifier, for sending the second portion of the plurality of data segments.

In some implementations of method 1000, the UE-specific network identifier comprises a cell-radio network temporary identifier (C-RNTI).

In some implementations of method 1000, the UE communication component 121, such as in conjunction with transceiver 1202, processor 1212, memory 1216, or modem 1240, is configured to transmit, in a RRC inactive state, the second portion of the plurality of data segments to the network entity based on the dynamic scheduling information.

In some implementations of method 1000, a transmit buffer is empty based on transmitting the second portion of the plurality of data segments to the network entity, and further comprising generating, by an application layer of the UE, an additional data segment for transmission to the network entity subsequent to transmitting the second portion of the plurality of data segments.

In some implementations of method 1000, the UE communication component 121, such as in conjunction with transceiver 1202, processor 1212, memory 1216, or modem 1240, is configured to perform a second RACH procedure including the additional data segment in response to generating the additional data segment for transmission to the network entity subsequent to transmitting the second portion of the plurality of data segments.

In some implementations of method 1000, the communicating component 121, such as in conjunction with transceiver 1202, processor 1212, memory 1216, or modem 1240, is configured to transmitting a scheduling request to the network entity in response to generating the additional data segment for transmission to the network entity subsequent to transmitting the second portion of the plurality of data segments, wherein the scheduling request asks the network entity to configure additional uplink grant resources for the UE in a RRC inactive state.

In some implementations of method 1000, the UE communication component 121, such as in conjunction with transceiver 1202, processor 1212, memory 1216, or modem 1240, configured to transmit the scheduling request further comprises transmitting the scheduling request using a physical uplink control channel (PUCCH) resource requiring the network entity to configure the additional uplink grant resources for the UE in the RRC inactive state.

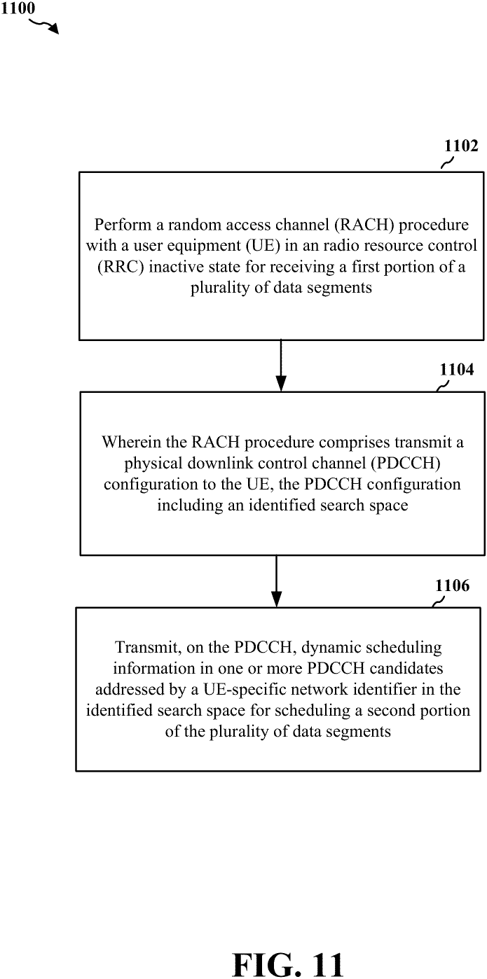

Referring to FIG. 11, an example method 1100 of wireless communication may be performed by the network entity 102, which may include one or more components as discussed in FIGS. 1, 4, or 13, and which may transfer data segments after performing a RACH procedure as discussed above with regard to FIGS. 1-4 and 7-8.

At 1102, method 1100 includes performing a RACH procedure with a UE in an RRC inactive state for receiving a first portion of a plurality of data segments. For example, in an aspect, the network entity 102 may operate one or any combination of antennas 1365, RF front end 1388, transceiver 1302, processor 1312, memory 1316, modem 1340, or base station communication component 127 to perform a RACH procedure with a UE in an RRC inactive state for receiving a first portion of a plurality of data segments. Thus, the network entity 102, antennas 1365, RF front end 1388, transceiver 1302, processor 1312, memory 1316, modem 1340, and base station communication component 127 may define the means for performing a RACH procedure with a UE in an RRC inactive state for receiving a first portion of a plurality of data segments. For instance, performing the RACH procedure for transferring a first portion of a plurality of data segments from the UE to the network entity during a RRC inactive state at 1102 includes, for example, steps 1 and 2 of FIG. 7 and/or steps 1 through 4 of FIG. 8.

At 1104, method 1100 includes wherein the RACH procedure comprises transmitting a PDCCH configuration to the UE, the PDCCH configuration including an identified search space. For example, in an aspect, the network entity 102 may operate one or any combination of antennas 1365, RF front end 1388, transceiver 1302, processor 1312, memory 1316, modem 1340, or base station communication component 127 to transmit a PDCCH configuration to the UE as a part of the RACH procedure, the PDCCH configuration including an identified search space. Thus, the network entity 102, antennas 1365, RF front end 1388, transceiver 1302, processor 1312, memory 1316, modem 1340, and base station communication component 127 may define the means for wherein the RACH procedure comprises transmitting a PDCCH configuration to the UE, the PDCCH configuration including an identified search space. For instance, performing the RACH procedure for transferring a first portion of a plurality of data segments from the UE to the network entity during a RRC inactive state at 1104 includes, for example, step 2 of FIG. 7 and/or step 4 of FIG. 8.

At 1106, method 1100 includes transmitting, on the PDCCH, dynamic scheduling information in one or more PDCCH candidates addressed by a UE-specific network identifier in the identified search space for scheduling a second portion of the plurality of data segments. For example, in an aspect, the network entity 102 may operate one or any combination of antennas 1365, RF front end 1388, transceiver 1302, processor 1312, memory 1316, modem 1340, or base station communication component 127 to transmit, on the PDCCH, dynamic scheduling information in one or more PDCCH candidates addressed by a UE-specific network identifier in the identified search space for scheduling a second portion of the plurality of data segments. Thus, the network entity 102, antennas 1365, RF front end 1388, transceiver 1302, processor 1312, memory 1316, modem 1340, and base station communication component 127 may define the means for transmitting, on the PDCCH, dynamic scheduling information in one or more PDCCH candidates addressed by a UE-specific network identifier in the identified search space for scheduling a second portion of the plurality of data segments. For instance, performing the RACH procedure for transferring a first portion of a plurality of data segments from the UE to the network entity during a RRC inactive state at 1106 includes, for example, step 2 of FIG. 7 and/or step 4 of FIG. 8.

In some implementations of method 1100, the identified search space comprises a UE-specific search space, or a common search space, such as but not limited to a random access-specific search space.

In some implementations of method 1100, the communicating component 127, such as in conjunction with transceiver 1302, processor 1312, memory 1316, or modem 1340, configured to perform the RACH procedure with the UE for receiving the first portion of the plurality of data segments further comprises receiving a small data request message including a buffer status report indicating a buffer value corresponding to the second portion of the plurality of data segments.

In some implementations of method 1100, the communicating component 127, such as in conjunction with transceiver 1302, processor 1312, memory 1316, or modem 1340, configured to transmit the PDCCH configuration further comprises transmitting the PDCCH configuration including and identified search space in a RRC release message.

In some implementations of method 1100, the communicating component 127, such as in conjunction with transceiver 1302, processor 1312, memory 1316, or modem 1340, configured to transmitting the PDCCH configuration further comprises transmitting the PDCCH configuration in a RRC release message including a suspend configuration indicator for maintaining the UE in a RRC inactive state.

In some implementations of method 1100, the UE-specific network identifier comprises a C-RNTI.

In some implementations of method 1100, the communicating component 127, such as in conjunction with transceiver 1302, processor 1312, memory 1316, or modem 1340, configured to transmit the dynamic scheduling information includes transmitting scheduling data packets that schedule resources in at least one of an uplink channel or a downlink channel.

In some implementations of method 1100, the communicating component 127, such as in conjunction with transceiver 1302, processor 1312, memory 1316, or modem 1340, is configured to transmit a downlink response message to the UE, the downlink response message including the dynamic scheduling information for an uplink transmission, using the UE-specific network identifier, for sending the second portion of the plurality of data segments.

In some implementations of method 1100, the communicating component 127, such as in conjunction with transceiver 1302, processor 1312, memory 1316, or modem 1340, configured to the UE-specific network identifier comprises a C-RNTI.

In some implementations of method 1100, the communicating component 127, such as in conjunction with transceiver 1302, processor 1312, memory 1316, or modem 1340, configured to receiving, in a RRC inactive state, the second portion of the plurality of data segments from the UE based on the dynamic scheduling information.

In some implementations of method 1100, the communicating component 127, such as in conjunction with transceiver 1302, processor 1312, memory 1316, or modem 1340, is configured to transmit an ACK to the UE in response to receiving the second portion of the plurality of data segments.

In some implementations of method 1100, the communicating component 127, such as in conjunction with transceiver 1302, processor 1312, memory 1316, or modem 1340, is configured to perform a second RACH procedure to receive an additional data segment generated by the UE subsequent to the UE transmitting the second portion of the plurality of data segments.

In some implementations of method 1100, the communicating component 127, such as in conjunction with transceiver 1302, processor 1312, memory 1316, or modem 1340, is configured to receive a scheduling request from the UE to schedule transmission of an additional data segment generated by the UE subsequent to the UE transmitting the second portion of the plurality of data segments, wherein the scheduling request asks the network entity to configure additional uplink grant resources for the UE in a RRC inactive state.

In some implementations of method 1100, the communicating component 127, such as in conjunction with transceiver 1302, processor 1312, memory 1316, or modem 1340, configured to receive the scheduling request further comprises receiving the scheduling request using a PUCCH resource requiring the network entity to configure the additional uplink grant resources for the UE in the RRC inactive state.

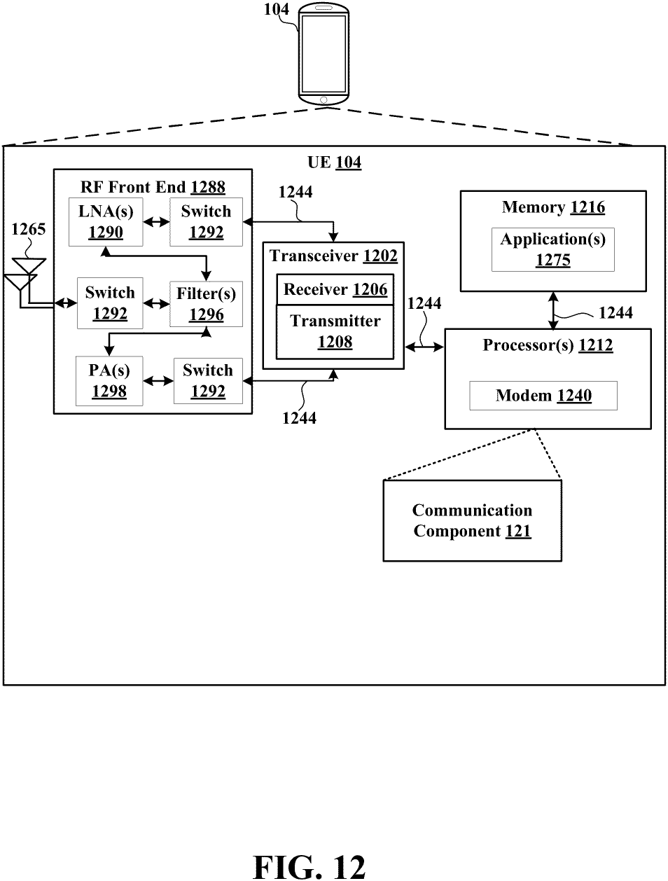

Referring to FIG. 12, one example of an implementation of UE 104 may include a variety of components, some of which have already been described above and are described further herein, including components such as one or more processors 1212 and memory 1216 and transceiver 1202 in communication via one or more buses 1244, which may operate in conjunction with modem 1240 and/or UE communication component 121 configured for transferring data segments after performing a RACH procedure.

In an aspect, the one or more processors 1212 can include a modem 1240 and/or can be part of the modem 1240 that uses one or more modem processors. Thus, the various functions related to configuration component 198 may be included in modem 1240 and/or processors 1212 and, in an aspect, can be executed by a single processor, while in other aspects, different ones of the functions may be executed by a combination of two or more different processors. For example, in an aspect, the one or more processors 1212 may include any one or any combination of a modem processor, or a baseband processor, or a digital signal processor, or a transmit processor, or a receiver processor, or a transceiver processor associated with transceiver 1202. In other aspects, some of the features of the one or more processors 1212 and/or modem 1240 associated with configuration component 198 may be performed by transceiver 1202.

Also, memory 1216 may be configured to store data used herein and/or local versions of applications 1275 or communicating component 1242 and/or one or more of its subcomponents being executed by at least one processor 1212. Memory 1216 can include any type of computer-readable medium usable by a computer or at least one processor 1212, such as random access memory (RAM), read only memory (ROM), tapes, magnetic discs, optical discs, volatile memory, non-volatile memory, and any combination thereof. In an aspect, for example, memory 1216 may be anon-transitory computer-readable storage medium that stores one or more computer-executable codes defining UE communication component 121 and/or one or more of its subcomponents, and/or data associated therewith, when UE 104 is operating at least one processor 1212 to execute UE communication component 121 and/or one or more of its subcomponents.

Transceiver 1202 may include at least one receiver 1206 and at least one transmitter 1208. Receiver 1206 may include hardware and/or software executable by a processor for receiving data, the code comprising instructions and being stored in a memory (e.g., computer-readable medium). Receiver 1206 may be, for example, a radio frequency (RF) receiver. In an aspect, receiver 1206 may receive signals transmitted by at least one base station 102. Additionally, receiver 1206 may process such received signals, and also may obtain measurements of the signals, such as, but not limited to, Ec/Io, signal-to-noise ratio (SNR), reference signal received power (RSRP), received signal strength indicator (RSSI), etc. Transmitter 1208 may include hardware and/or software executable by a processor for transmitting data, the code comprising instructions and being stored in a memory (e.g., computer-readable medium). A suitable example of transmitter 1208 may including, but is not limited to, an RF transmitter.

Moreover, in an aspect, UE 104 may include RF front end 1288, which may operate in communication with one or more antennas 1265 and transceiver 1202 for receiving and transmitting radio transmissions, for example, wireless communications transmitted by at least one base station 102 or wireless transmissions transmitted by UE 104. The one or more antennas 1265 may include one or more antenna panels and/or sub-arrays, such as may be used for beamforming. RF front end 1288 may be connected to one or more antennas 1265 and can include one or more low-noise amplifiers (LNAs) 1290, one or more switches 1292, one or more power amplifiers (PAs) 1298, and one or more filters 1296 for transmitting and receiving RF signals.

In an aspect, LNA 1290 can amplify a received signal at a desired output level. In an aspect, each LNA 1290 may have a specified minimum and maximum gain values. In an aspect, RF front end 1288 may use one or more switches 1292 to select a particular LNA 1290 and its specified gain value based on a desired gain value for a particular application.

Further, for example, one or more PA(s) 1298 may be used by RF front end 1288 to amplify a signal for an RF output at a desired output power level. In an aspect, each PA 1298 may have specified minimum and maximum gain values. In an aspect, RF front end 1288 may use one or more switches 1292 to select a particular PA 1298 and its specified gain value based on a desired gain value for a particular application.

Also, for example, one or more filters 1296 can be used by RF front end 1288 to filter a received signal to obtain an input RF signal. Similarly, in an aspect, for example, a respective filter 1296 can be used to filter an output from a respective PA 1298 to produce an output signal for transmission. In an aspect, each filter 1296 can be connected to a specific LNA 1290 and/or PA 1298. In an aspect, RF front end 1288 can use one or more switches 1292 to select a transmit or receive path using a specified filter 1296, LNA 1290, and/or PA 1298, based on a configuration as specified by transceiver 1202 and/or processor 1212.

As such, transceiver 1202 may be configured to transmit and receive wireless signals through one or more antennas 1265 via RF front end 1288. In an aspect, transceiver may be tuned to operate at specified frequencies such that UE 104 can communicate with, for example, one or more base stations 102 or one or more cells associated with one or more base stations 102. In an aspect, for example, modem 1240 can configure transceiver 1202 to operate at a specified frequency and power level based on the UE configuration of the UE 104 and the communication protocol used by modem 1240.

In an aspect, modem 1240 can be a multiband-multimode modem, which can process digital data and communicate with transceiver 1202 such that the digital data is sent and received using transceiver 1202. In an aspect, modem 1240 can be multiband and be configured to support multiple frequency bands for a specific communications protocol. In an aspect, modem 1240 can be multimode and be configured to support multiple operating networks and communications protocols. In an aspect, modem 1240 can control one or more components of UE 104 (e.g., RF front end 1288, transceiver 1202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, the processor(s) 1212 may correspond to one or more of the processors described in connection with the UE in FIG. 4. Similarly, the memory 1216 may correspond to the memory described in connection with the UE in FIG. 4.

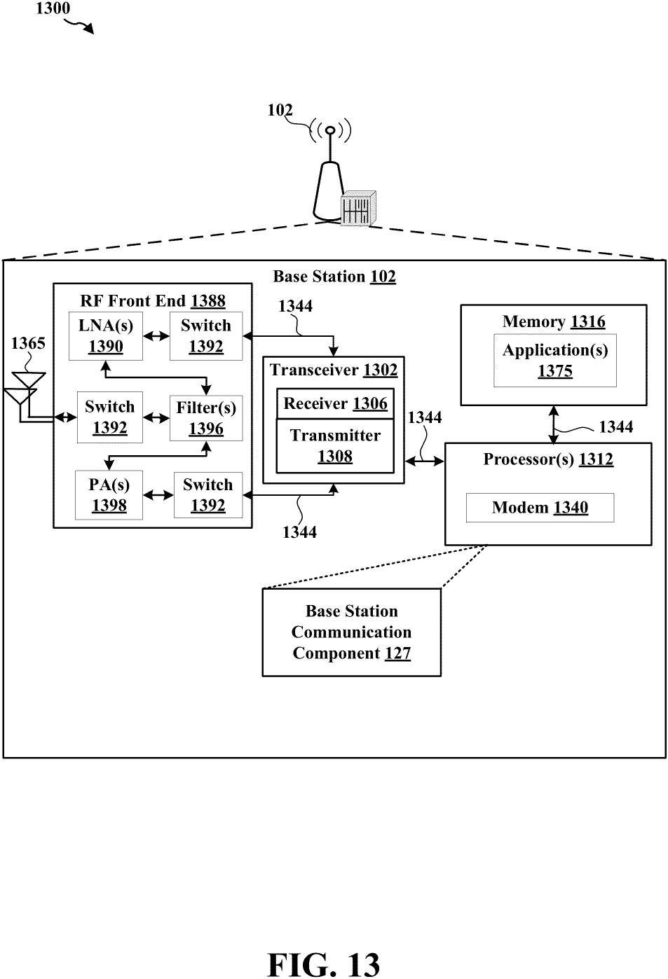

Referring to FIG. 13, one example of an implementation of base station 102 (e.g., a base station 102, as described above) may include a variety of components, some of which have already been described above, but including components such as one or more processors 1312 and memory 1316 and transceiver 1302 in communication via one or more buses 1344, which may operate in conjunction with modem 1340 and base station communication component 137 configured to transfer data segments after performing a RACH procedure.

The transceiver 1302, receiver 1306, transmitter 1308, one or more processors 1312, memory 1316, applications 1375, buses 1344, RF front end 1388, LNAs 1390, switches 1392, filters 1396, PAs 1398, and one or more antennas 1365 may be the same as or similar to the corresponding components of UE 104, as described above, but configured or otherwise programmed for base station operations as opposed to UE operations.

In an aspect, the processor(s) 1312 may correspond to one or more of the processors described in connection with the base station in FIG. 4. Similarly, the memory 1316 may correspond to the memory described in connection with the base station in FIG. 4.

An Appendix is included that is part of the present application and provides additional details related to the various aspects of the present disclosure.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), comprising:
performing a random access channel (RACH) procedure with a network entity for transferring a first portion of a plurality of data segments from the UE to the network entity during a radio resource control (RRC) inactive state,
wherein the RACH procedure comprises receiving a physical downlink control channel (PDCCH) configuration from the network entity, the PDCCH configuration including an identified search space; and
monitoring a PDCCH for PDCCH candidates addressed by a UE-specific network identifier in the identified search space for dynamic scheduling information that schedules a second portion of the plurality of data segments.

2. The method of claim 1, wherein the identified search space comprises a UE-specific search space, or a common search space.

3. The method of claim 1, wherein performing the RACH procedure with the network entity for transferring the first portion of the plurality of data segments further comprises transmitting a small data request message including a buffer status report indicating a buffer value corresponding to the second portion of the plurality of data segments.

4. The method of claim 1, wherein receiving the PDCCH configuration further comprises receiving the PDCCH configuration including the identified search space in an RRC message, and wherein the UE-specific network identifier comprises a cell-radio network temporary identifier (C-RNTI).

5. (canceled)

6. The method of claim 1, wherein monitoring the PDCCH for the dynamic scheduling information that schedules the second portion of the plurality of data segments includes monitoring for scheduling data packets that schedule resources in at least one of an uplink channel or a downlink channel.

7. The method of claim 1, further comprising receiving a downlink response message from the network entity, the downlink response message including the dynamic scheduling information for an uplink transmission, using the UE-specific network identifier, for sending the second portion of the plurality of data segments.

8. (canceled)

9. The method of claim 1, further comprising transmitting, in the RRC inactive state, the second portion of the plurality of data segments to the network entity based on the dynamic scheduling information.

10. The method of claim 9, wherein a transmit buffer is empty based on transmitting the second portion of the plurality of data segments to the network entity, and further comprising:
generating, by an application layer of the UE, an additional data segment for transmission to the network entity subsequent to transmitting the second portion of the plurality of data segments;
performing a second RACH procedure including the additional data segment in response to generating the additional data segment for transmission to the network entity subsequent to transmitting the second portion of the plurality of data segments; and
monitoring the PDCCH in the identified search space for the dynamic scheduling information after the second RACH procedure for the additional data segment for transmission in at least one of an uplink channel or a downlink channel using the UE-specific network identifier.

11. (canceled)

12. (canceled)

13. The method of claim 10, further comprising transmitting a scheduling request to the network entity in response to generating the additional data segment for transmission to the network entity subsequent to transmitting the second portion of the plurality of data segments, wherein the scheduling request asks the network entity to configure additional uplink grant resources for the UE in the RRC inactive state, and wherein transmitting the scheduling request includes using a physical uplink control channel (PUCCH) resource requiring the network entity to configure the additional uplink grant resources for the UE in the RRC inactive state.

14. (canceled)

15. A method of wireless communication by a base station, comprising:
performing a random access channel (RACH) procedure with a user equipment (UE) in an radio resource control (RRC) inactive state for receiving a first portion of a plurality of data segments,
wherein the RACH procedure comprises transmitting a physical downlink control channel (PDCCH) configuration to the UE, the PDCCH configuration including an identified search space; and
transmitting, on a PDCCH, dynamic scheduling information in one or more PDCCH candidates addressed by a UE-specific network identifier in the identified search space for scheduling a second portion of the plurality of data segments.

16. The method of claim 15, wherein the identified search space comprises a UE-specific search space, or a common search space.

17. The method of claim 15, wherein performing the RACH procedure with the UE for receiving the first portion of the plurality of data segments further comprises receiving a small data request message including a buffer status report indicating a buffer value corresponding to the second portion of the plurality of data segments.

18. The method of claim 15, wherein transmitting the PDCCH configuration further comprises transmitting the PDCCH configuration including the identified search space in an RRC message, wherein the UE-specific network identifier comprises a cell-radio network temporary identifier (C-RNTI).

19. (canceled)

20. The method of claim 15, wherein transmitting the dynamic scheduling information includes transmitting scheduling data packets that schedule resources in at least one of an uplink channel or a downlink channel.

21. The method of claim 15, further comprising transmitting a downlink response message to the UE, the downlink response message including the dynamic scheduling information for an uplink transmission, using the UE-specific network identifier, for sending the second portion of the plurality of data segments.

22-28. (canceled)

29. An apparatus for wireless communication, comprising:
a transceiver;
a memory; and
one or more processors coupled with the transceiver and the memory, the memory including instructions executable by the one or more processors to cause the apparatus to:
perform a random access channel (RACH) procedure with a network entity for transferring a first portion of a plurality of data segments from the apparatus to the network entity during a radio resource control (RRC) inactive state,
wherein the RACH procedure comprises to receive a physical downlink control channel (PDCCH) configuration from the network entity, the PDCCH configuration including an identified search space; and
monitor a PDCCH for PDCCH candidates addressed by a UE-specific network identifier in the identified search space for dynamic scheduling information that schedules a second portion of the plurality of data segments.

30. (canceled)

31. (canceled)

32. The apparatus of claim 29, wherein the identified search space comprises a UE-specific search space, or a common search space.

33. The apparatus of claim 29, wherein to perform the RACH procedure with the network entity for transferring the first portion of the plurality of data segments further comprises the one or more processors configured to cause the apparatus to transmit a small data request message including a buffer status report indicating a buffer value corresponding to the second portion of the plurality of data segments.

34. The apparatus of claim 29, wherein the PDCCH configuration including the identified search space is in an RRC message, and wherein the UE-specific network identifier comprises a cell-radio network temporary identifier (C-RNTI).

35. The apparatus of claim 29, wherein to monitor the PDCCH for the dynamic scheduling information that schedules the second portion of the plurality of data segments further comprises the one or more processors configured to cause the apparatus to monitor for scheduling data packets that schedule resources in at least one of an uplink channel or a downlink channel.

36. The apparatus of claim 29, further comprising the one or more processors configured to cause the apparatus to receive a downlink response message from the network entity, the downlink response message including the dynamic scheduling information for an uplink transmission, using the UE-specific network identifier, for sending the second portion of the plurality of data segments.

37. The apparatus of claim 29, further comprising the one or more processors configured to cause the apparatus to transmit, in the RRC inactive state, the second portion of the plurality of data segments to the network entity based on the dynamic scheduling information.

38. The apparatus of claim 37, wherein a transmit buffer is empty based on a transmission of the second portion of the plurality of data segments to the network entity, and further comprising the one or more processors configured to cause the apparatus to:
generate, by an application layer of the apparatus, an additional data segment for transmission to the network entity subsequent to transmitting the second portion of the plurality of data segments;
performing a second RACH procedure including the additional data segment in response to generating the additional data segment for transmission to the network entity subsequent to transmitting the second portion of the plurality of data segments; and
monitoring the PDCCH in the identified search space for the dynamic scheduling information after the second RACH procedure for the additional data segment for transmission in at least one of an uplink channel or a downlink channel using the UE-specific network identifier.

39. The apparatus of claim 38, further comprising the one or more processors configured to cause the apparatus to transmit a scheduling request to the network entity in response to generating the additional data segment for transmission to the network entity subsequent to transmitting the second portion of the plurality of data segments, wherein the scheduling request asks the network entity to configure additional uplink grant resources for the UE in the RRC inactive state, and wherein to transmit the scheduling request includes to use a physical uplink control channel (PUCCH) resource requiring the network entity to configure the additional uplink grant resources for the apparatus in the RRC inactive state.

40. An apparatus for wireless communication, comprising:
a transceiver;
a memory; and
one or more processors coupled with the transceiver and the memory, the memory including instructions executable by the one or more processors to cause the apparatus to:
perform a random access channel (RACH) procedure with a user equipment (UE) in an radio resource control (RRC) inactive state for receiving a first portion of a plurality of data segments,
wherein the RACH procedure comprises to transmit a physical downlink control channel (PDCCH) configuration to the UE, the PDCCH configuration including an identified search space; and
transmit, on a PDCCH, dynamic scheduling information in one or more PDCCH candidates addressed by a UE-specific network identifier in the identified search space for scheduling a second portion of the plurality of data segments.

41. The apparatus of claim 40, wherein the identified search space comprises a UE-specific search space, or a common search space.

42. The apparatus of claim 40, wherein to perform the RACH procedure with the UE for receiving the first portion of the plurality of data segments further comprises the one or more processors configured to cause the apparatus to receive a small data request message including a buffer status report indicating a buffer value corresponding to the second portion of the plurality of data segments.

43. The apparatus of claim 40, wherein to transmit the PDCCH configuration further comprises the one or more processors configured to cause the apparatus to transmit the PDCCH configuration including the identified search space in an RRC message, wherein the UE-specific network identifier comprises a cell-radio network temporary identifier (C-RNTI).

44. The apparatus of claim 40, wherein to transmit the dynamic scheduling information includes to transmit scheduling data packets that schedule resources in at least one of an uplink channel or a downlink channel.

45. The apparatus of claim 40, further comprising the one or more processors configured to cause the apparatus to transmit a downlink response message to the UE, the downlink response message including the dynamic scheduling information for an uplink transmission, using the UE-specific network identifier, for sending the second portion of the plurality of data segments.
